(19) United States
(12) Patent Application Publication
(10) Pub. No.: US 2026/0070370 A1
(43) Pub. Date: Mar. 12, 2026

(54) Multi-Bearing Caster Wheel

(71) Applicant: East Java Enterprise, L.L.C., Bayside, NY (US)

(72) Inventor: Ali Budiman, Bayside, NY (US)

(73) Assignee: East Java Enterprise, L.L.C., Bayside, NY (US)

(21) Appl. No.: 18/826,284

(22) Filed: Sep. 6, 2024

(51) Int. Cl. B60B 33/00

(52) U.S. Cl. CPC B60B 33/0042

(57) ABSTRACT

A caster wheel is configured with multiple bearings and wheels to create an overall stronger and more fluid moving wheel for office chairs. The caster wheel has a main body that forms an L-shaped structure and has two perpendicularly oriented offset bores extending fully through, A vertically stem extends through the vertically oriented bore, and the vertical stem extends out a top portion of the body, and the stem's body extends at least partially out the bottom of the main body. The vertical stem includes two bearings, one on an upper portion of the stem and one at a bottom portion of the stem. A horizontally oriented stem is positioned within the horizontal bore and extends out both sides of the body. Opposing wheels connect to each end of the stem and there are two bearings on opposing sides of the horizontal stem.

### CROSS-REFERENCES TO RELATED APPLICATION

This Non-Provisional Patent Application is related to co-pending Design patent application Ser. No. 29/961,542, filed contemporaneously herewith on Sep. 6, 2024, entitled “Multi-Bearing Caster Wheel,” the entire contents of which are hereby incorporated herein by reference.

### BACKGROUND

Office chairs employ caster wheels on which a chair rests and which provide support and maneuverability of the office chair while the user sits. While an array of styles of caster wheels and office chairs are present, some caster wheels break easily due to the pressure from a user's weight. Occasionally, internal parts of a caster wheel can damage, such as a bearing, which prevents the wheel from properly maneuvering and the overall use of the chair.

### SUMMARY

A caster wheel is configured with multiple bearings and wheels to create an overall stronger and more fluid moving wheel for office chairs. The caster wheel has a main body that forms an L-shaped structure—however, other shapes/designs of the main body are also possible. The main body has two perpendicularly oriented bores extending fully through, and each bore is offset from the other so as not to cross paths. A vertically stem extends through the vertically oriented bore, and the vertical stem extends out a top portion of the body, and the stem's body extends at least partially out the bottom of the main body. The vertical stem includes two bearings, one on an upper portion of the stem and one at a bottom portion of the stem. Each bearing rests on a seat inside of the main body. The bearings allow the chair to rotate bi-directionally.

Offset from the vertically extending stem, a horizontally oriented stem is positioned within the horizontal bore and extends out both sides of the body. Opposing wheels connect to each end of the stem for a total of two wheels for the caster wheel. One bearing is utilized for each wheel, one positioned on each end of the wheel's center hole. The two vertical stem bearings and two horizontal stem bearings account for a total of four bearings for the caster wheel structure, providing an environment in which exterior exertion is dispersed throughout the various bearings to create a stronger, sturdier, efficient, and reliable caster wheel.

### BRIEF DESCRIPTION OF THE DRAWINGS

FIG. 1 shows an illustrative representation of an office chair with multiple caster wheels;

FIGS. 2-5 show illustrative representations of the caster wheel from various viewpoints;

FIG. 6 shows an illustrative exploded view of the caster wheel, showing multiple bearings positioned along vertical and horizontal stems;

FIG. 7 shows an illustrative cross-sectional representation of section B-B from FIG. 5; and

FIG. 8 shows an illustrative cross-sectional representation of section A-A from FIG. 4.

### DETAILED DESCRIPTION

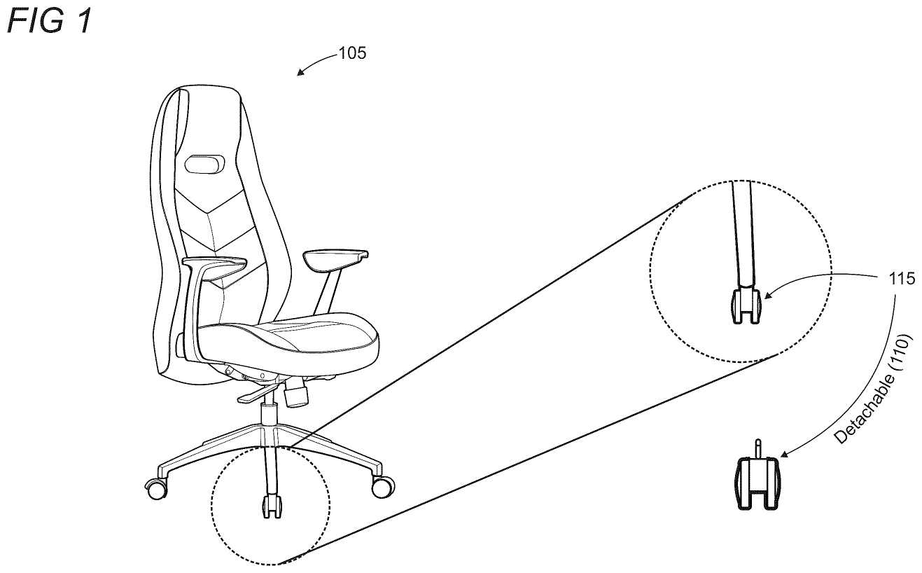

FIG. 1 shows an illustrative representation in which a series of caster wheels 115 support an office chair 105. The caster wheels are releasably attached to arms extending from a base that the office chair is attached to. As shown, the caster wheel 115 includes a stem that provides detachability 110 from the office chair via a connector-receptacle arrangement. The terms caster wheel or just wheel may be used interchangeably herein to reference the caster wheel 115 discussed herein and shown in the drawings. The caster wheel shown and described herein is exemplary only, and other caster wheels may likewise be configured with multiple bearings using the techniques discussed herein, including other configurations of swivel caster wheels, kingpinless caster wheels, etc.

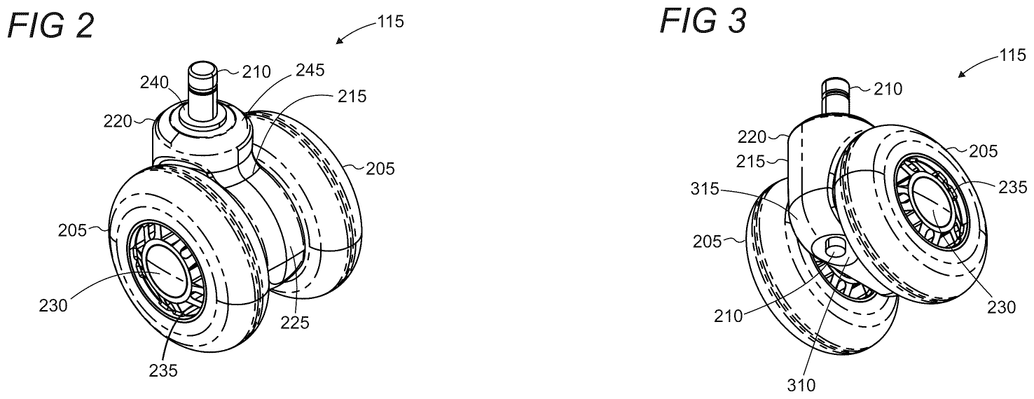

FIGS. 2-5 show illustrative representations of the caster wheel 115 from various angles to show the caster wheels exterior makeup. The caster wheel includes a vertical stem 210 that extends substantially vertically and linearly through an interior bore within the wheel's main body 215. In typical implementations, the main body may be comprised of a plastic, metal, or other suitable polymer, and the vertical stem and various internal components may be comprised of a metal to be sufficiently durable.

However, other materials may also be used for the various components, whether plastic, metal, etc. The main body 215 forms a L-shaped design that includes an upper body 220 and a front lower body 225 (FIG. 2) and rear lower body 315 (FIG. 3). The vertical stem 210 extends fully from the top to the bottom of the main body, and, in typical implementations, extends beyond the main body's top and bottom edges. For example, FIG. 3 shows the bottom of the vertical stem extending beyond the main body, and the lower bearing 310 is exposed.

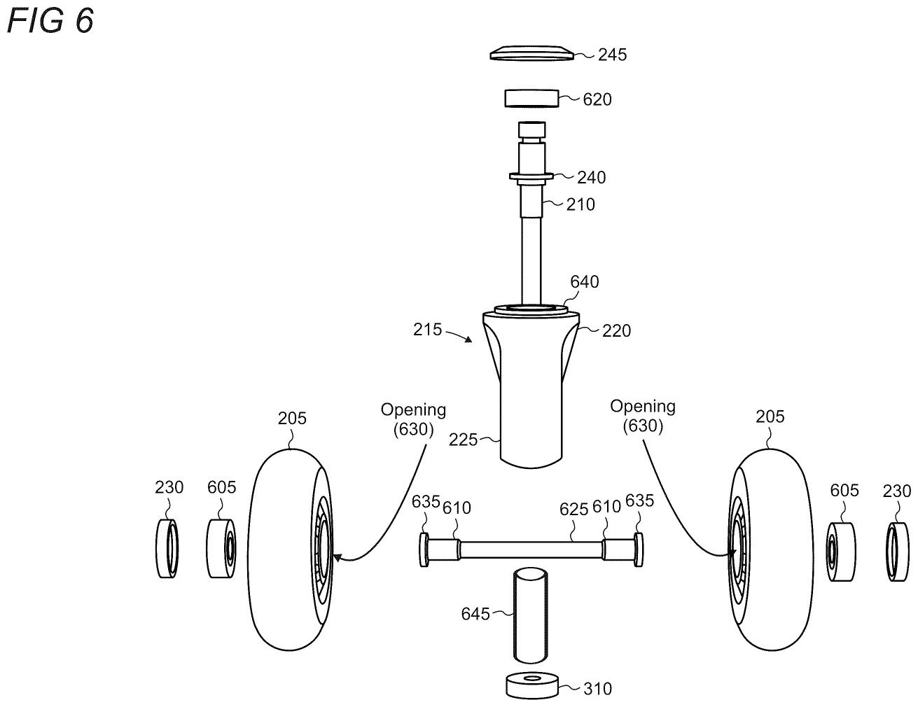

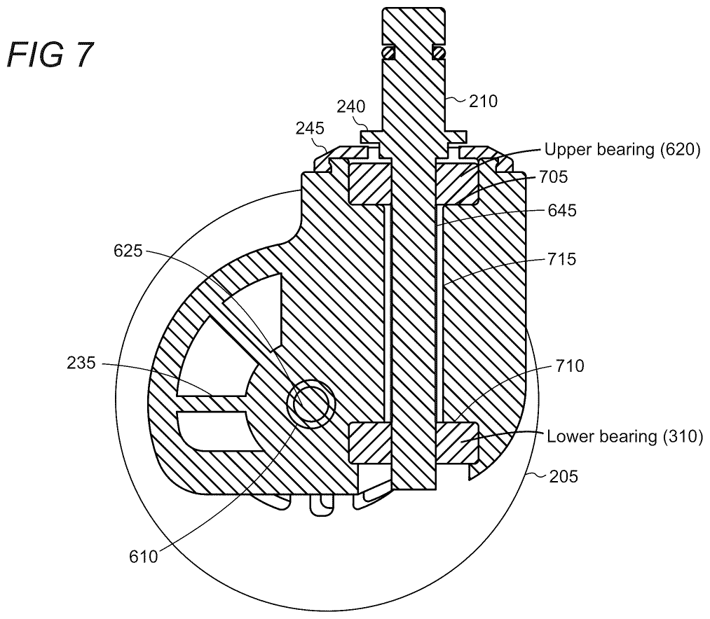

The vertical stem 210 includes an upper flange that helps secure the structure together. A cap 245 secures underneath the flange 240 and may contribute to holding a bearing (FIGS. 6 and 7) in place. However, the bearing may be mounted to the vertical stem via a lock collar mechanism, as discussed below. The caps are secured to the wheel via a press-fit mechanism to seal the wheel's internal components. The wheels 205 are positioned around a horizontal stem (not shown in FIGS. 1-5, see FIGS. 6-8), and are locked in place with caps 230. In this implementation, spokes 235 are shown around the cap and form the wheel's central hub or opening.

FIG. 6 shows an illustrative exploded representation of the caster wheel 115. Starting first with the horizontal assembly of components. The horizontal stem 625 is substantially linear and extends beyond opposing lateral sides of the main body 215. The horizontal stem extends beyond and through each respective wheel's central hub or opening 630. Supports 610 include bores and are positioned on the horizontal stem's body. The supports 610 include flanges 635 on the outside portion around which opposing horizontal bearings 605 are positioned and rotate. The flanges are part of the supports overall structure, such as welded or otherwise manufactured as a unitary piece. Thus, the horizontal stem includes two bearings, one dedicated for each wheel, to increase the wheel's rotational ability, stability, and longevity. For example, by placing a bearing on opposite sides of the stem and dedicated for each wheel, friction and pressure is able to disperse between each bearing to thereby increase the caster wheel's overall strength. In other bearing placement scenarios, the breaking of a bearing can damage the wheel's overall use, thereby forcing the user to either replace the wheel or endure a damaged wheel on their office chair 105.

The vertical stem 210 is likewise configured with two bearings, an upper bearing 620 and a lower bearing 310. The vertical stem's bearings are utilized to accommodate bidirectional rotational movements about a longitudinal axis of the vertical stem, such movements are perpendicular to the wheel's bidirectional rotational movements. The upper bearing 620 is around the stem and is positioned within an interior of the main body 215. The main body rests underneath the flange 240 and then is locked in place with the cap 245, which connects (e.g., pressfits) to the seat 640. A washer 650 is also present around the vertical stem and may be positioned between the upper bearing 620 and the seat inside the main body.

The bottom bearing 310 is positioned within the main body's vertical opening, but, as shown and described with respect to FIG. 3 above, is observable from a bottom of the caster wheel 115. Above the bottom bearing is a hollow cylinder 645 that inserts into the interior of the main body 215 and into which the step 210 inserts. The cylinder provides a support barrier between stem and the main body's hollow interior bore. The cylinder 645 extends up to and substantially engages or contacts the bottom of the upper bearing 620 (FIG. 6). The cylinder is essentially positioned between the upper bearing 620 and the lower bearing 310.

The two vertical bearings provide enhanced support and rotatability to the wheel. For example, rotational movement, weight, and pressure from a user when sitting on the office chair 105 are exerted across each bearing, thereby reducing the amount of strain applied to a single bearing. By dispersing these various outside forces, such rotational movements are thereby easier to attain, smoother, and will be harder to break or damage. In other vertical bearing arrangements, too much pressure may be exerted against a bearing causing it to break over time. The present arrangement provides a longer lasting and better quality overall caster wheel 115.

The unitary structure of the caster wheel is achieved by compressing the ends of the assembled vertical and horizontal stem, which include collars at the ends to prevent movement. The ends and collars of the stems are compressed to achieve a sealed unit and thereby prevent the components from disassembly or breaking apart.

FIG. 7 shows an illustrative cross-sectional representation of section B-B from FIG. 5, in which the upper bearing 620 bearing and lower bearing engage with seats 705, 710, respectively within the main body's vertical bore 715. The upper and lower bearings may be mounted to the vertical stem via a locking collar during assembly. For example, the bearings may be secured in place via a setscrew lock, eccentric lock, concentric lock, tapered adapter sleeve lock, among other designs. Furthermore, the horizontal stem 625 is offset from the vertical stem's positioning within the main body 215. Such an off-set arrangement may provide sufficient real estate for the main body to cater to the vertical and horizontal stem's operations. The hollow cylinder 645 is positioned around the vertical stem's body and is positioned and substantially engages or contacts the upper and lower bearings 620, 310. The cylinder's width substantially corresponds top the vertical bore 715, but, in some implementations, there may be a one or more millimeters of space between the cylinder and the bore's perimeter.

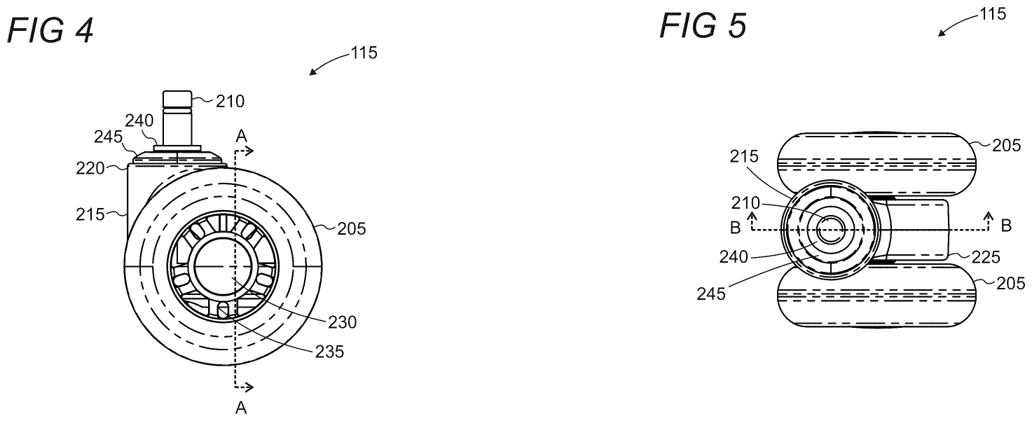

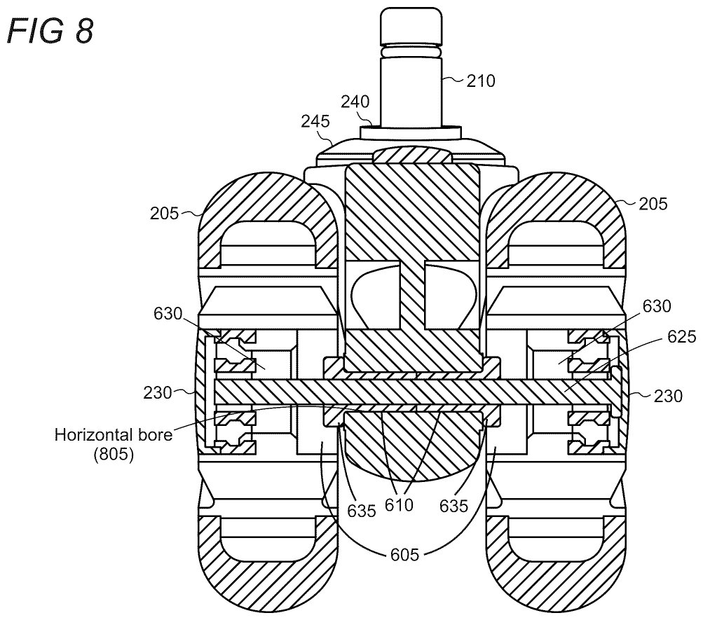

FIG. 8 shows an illustrative cross-sectional representation of section A-A from FIG. 4, in which the supports 610 are positioned within a horizontal bore 805. The interior ends of the supports are either fully or substantially engaging or positioned a distance from each other, and the flanges 635 rest against the main body's outer side surfaces. Over the flanges are left and right horizontal bearings 605 about which the bearings rotate to provide the rotational movement. The left and right bearings are positioned on opposing left and right sides of the horizontal stem, respectively. Similar to the upper and lower vertical bearings 620, 310, the left and right horizontal bearings may be mounted to the horizontal stem via a locking collar during assembly. For example, the bearings may be secured in place via a setscrew lock, eccentric lock, concentric lock, tapered adapter sleeve lock, among other designs.

As shown, the horizontal bearings 605 are each positioned inside their respective wheel's hub or opening 630. In this regard, the flanges provide a bridge in between the main body 215 and the wheels 205. Such a construction allows any external force, weight, pressure, and movements to be dispersed between the two bearings to thereby provide a sturdier structure and better rotational movement.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Various exemplary embodiments are shown and describes herein. In one exemplary embodiment, implemented is a caster wheel, comprising: a main body having a vertical bore and a horizontal bore; a vertical stem extending through the vertical bore; a horizontal stem extending through the horizontal bore; multiple bearings mounted to opposing sides of the horizontal stem; and multiple bearings mounted to opposing sides of the vertical stem.

In another example, the vertical and horizontal bores are offset from each other. In another example, the vertical stem extends beyond the main body's upper and bottom edges. As another example, each of the multiple bearings mounted to the horizontal stem are positioned around a flange. In another example, the flange is part of a support that extends within the main body's horizontal bore. As a further example, two wheels on opposing sides of the horizontal stem, wherein each bearing of the multiple bearings are encapsulated by opposing wheels. In another example, an upper bearing of the multiple bearings is positioned within a seat within the main body. As a further example, a bottom bearing of the multiple bearings is positioned at a seat on the main body, wherein the bottom bearing is externally observable from a bottom side of the main body. In another example, the vertical stem extends beyond the bottom bearing. As another example, the caster wheel substantially forms an L-shape.

In another exemplary embodiment, implemented is a method of assembling a caster wheel, comprising providing a main body having a vertical bore and a horizontal bore; inserting a vertical stem through the vertical bore; inserting a horizontal stem through the horizontal bore; mounting multiple bearings to opposing sides of the horizontal stem; and mounting multiple bearings to opposing sides of the vertical stem.

As another example, the vertical and horizontal bores are offset from each other. As a further example, the vertical stem extends beyond the main body's upper and bottom edges. In another example, each of the multiple bearings mounted to the horizontal stem are positioned around a flange. As another example, the flange is part of a support that extends within the main body's horizontal bore. As a further example, mounting two wheels on opposing sides of the horizontal stem, wherein each bearing of the multiple bearings are encapsulated by opposing wheels. As another example, an upper bearing of the multiple bearings is positioned within a seat within the main body. As a further example, a bottom bearing of the multiple bearings is positioned at a seat on the main body, wherein the bottom bearing is externally observable from a bottom side of the main body. In another example, the vertical stem extends beyond the bottom bearing. As another example, the caster wheel substantially forms an L-shape.

1. A caster wheel, comprising:
a main body having a vertical bore and a horizontal bore;
a vertical stem extending through the vertical bore;
a horizontal stem extending through the horizontal bore;
multiple bearings mounted to opposing sides of the horizontal stem; and
multiple bearings mounted to opposing sides of the vertical stem.

2. The caster wheel of claim 1, wherein the vertical and horizontal bores are offset from each other.

3. The caster wheel of claim 1, wherein the vertical stem extends beyond the main body's upper and bottom edges.

4. The caster wheel of claim 1, wherein each of the multiple bearings mounted to the horizontal stem are positioned around a flange.

5. The caster wheel of claim 4, wherein the flange is part of a support that extends within the main body's horizontal bore.

6. The caster wheel of claim 5, further comprising two wheels on opposing sides of the horizontal stem, wherein each bearing of the multiple bearings are encapsulated by opposing wheels.

7. The caster wheel of claim 1, wherein an upper bearing of the multiple bearings is positioned within a seat within the main body.

8. The caster wheel of claim 7, wherein a bottom bearing of the multiple bearings is positioned at a seat on the main body, wherein the bottom bearing is externally observable from a bottom side of the main body.

9. The caster wheel of claim 8, wherein the vertical stem extends beyond the bottom bearing.

10. The caster wheel of claim 1, wherein the caster wheel substantially forms an L-shape.

11. A method of assembling a caster wheel, comprising:
providing a main body having a vertical bore and a horizontal bore;
inserting a vertical stem through the vertical bore;
inserting a horizontal stem through the horizontal bore;
mounting multiple bearings to opposing sides of the horizontal stem; and
mounting multiple bearings to opposing sides of the vertical stem.

12. The method of claim 11, wherein the vertical and horizontal bores are offset from each other.

13. The method of claim 11, wherein the vertical stem extends beyond the main body's upper and bottom edges.

14. The method of claim 11, wherein each of the multiple bearings mounted to the horizontal stem are positioned around a flange.

15. The method of claim 14, wherein the flange is part of a support that extends within the main body's horizontal bore.

16. The method of claim 15, further comprising mounting two wheels on opposing sides of the horizontal stem, wherein each bearing of the multiple bearings are encapsulated by opposing wheels.

17. The method of claim 11, wherein an upper bearing of the multiple bearings is positioned within a seat within the main body.

18. The method of claim 17, wherein a bottom bearing of the multiple bearings is positioned at a seat on the main body, wherein the bottom bearing is externally observable from a bottom side of the main body.

19. The method of claim 18, wherein the vertical stem extends beyond the bottom bearing.

20. The method of claim 11, wherein the caster wheel substantially forms an L-shape.
